(19) United States
(12) Patent Application Publication
(10) Pub. No.: US 2021/0174295 A1
(43) Pub. Date: Jun. 10, 2021

(54) SYSTEMS AND METHODS FOR USER SELECTION OF WEARABLE ITEMS FOR NEXT SHIPMENT IN ELECTRONIC CLOTHING SUBSCRIPTION PLATFORM

(71) Applicant: CaaStle, Inc., New York, NY (US)

(72) Inventors: Vijay VENKATAKRISHNAN, Mountain View, CA (US); Tarun VERMA, New Delhi (IN); Georgiy GOLDENBERG, Los Altos, CA (US); Dongming JIANG, Los Angeles, CA (US); Kondala PALAKA, Fremont, CA (US); Arnab BHATTACHARYA, Uttar Pradesh (IN)

(21) Appl. No.: 16/702,848

(22) Filed: Dec. 4, 2019

(51) Int. Cl. G06Q 10/08

(52) U.S. Cl. CPC G06Q 10/0837; G06Q 10/0838

(57) ABSTRACT

Disclosed are methods, systems, and non-transitory computer-readable medium for user selection of wearable items for next shipment in electronic clothing subscription platform. For example, a method may include receiving a return notification of a user for one or more wearable items physically shipped to the user; determining whether the user is eligible to select one or more wearable items for a replacement physical shipment to the user; obtaining information regarding a plurality of predetermined wearable items; displaying the obtained information regarding the plurality of predetermined wearable items; and determining whether the user provides input based on the displayed information regarding the plurality of predetermined wearable items during a predetermined period of time.

### TECHNICAL FIELD

Various embodiments of the present disclosure generally relates to electronic transactions for initiating shipment of one or more wearable items in a clothing subscriptions platform, and more particularly, to electronic systems and methods for allocating one or more wearable items to a next or replacement physical shipment of a subscription electronic transactions platform.

### BACKGROUND

The clothing subscription model is based on a user signing up to receive a regular or periodic shipment of wearable items in return for a periodic (e.g., monthly) subscription fee that pays for usage of the wearable items as well as the logistics involved in sourcing and shipping the wearable items (e.g., shipping, laundry, handling, etc.). The user may become eligible to s a next shipment of wearable items when the user sends back the wearable items currently in possession of the user that had been sent to the user in an earlier shipment.

Two methods for selecting wearable items as part of a clothing subscription service for a user eligible for receiving the next shipment of wearable items (hereinafter referred to as a “box”) include: 1) the service picking a batched selection (hereinafter referred to as a service picks model), and 2) the user picking a selection (hereinafter referred to as a user picks model). The service picks model may work well for users who prefer to add wearable items to their box and who are not particular about which specific wearable item arrives in the next box. The service picks model may also be referred to as the everyday use case model.

With respect to the user picks model, the entire available inventory managed by the service is displayed to the user once the user becomes eligible for the next box. The user may pick each specific item they would like to receive from the inventory available at the time. The user picks model may work well for users that do not mind the overhead for selecting wearable items up to 2-3 times a week in return for the fine-grained control they get over wearable items they will receive in the upcoming box. In other words, the user may have a higher level of sensitivity in terms of the wearable items they will be receiving and wearing via the next box. The user picks model may also be referred to as the occasion use case model. The user picks model may require 3-4 times the inventory compared to the service picks model and may prevent the service from providing the user a more affordable price-point while being financially viable.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for user selection of wearable items for next shipment in electronic clothing subscription platform.

In one embodiments, a computer-implemented method comprises: receiving, by one or more processors, a return notification of a user for one or more wearable items physically shipped to the user in response to one or more electronic transactions of a subscription electronic transactions platform; determining, by the one or more processors, whether the user is eligible to select one or more wearable items for a replacement physical shipment to the user upon receiving the return notification of the user; obtaining, by the one or more processors, information regarding a plurality of predetermined wearable items from one or more data storages of the subscription electronic transactions platform as a result of determining that the user is eligible to select one or more wearable items for the replacement physical shipment to the user; displaying, by the one or more processors, the obtained information regarding the plurality of predetermined wearable items; and determining, by the one or more processors, whether the user provides input based on the displayed information regarding the plurality of predetermined wearable items during a predetermined period of time.

In accordance with another embodiment, a computer system comprises: a data storage device storing processor-readable instructions; and a processor configured to execute the instructions to perform a method. The method may include: receiving a return notification of a user for one or more wearable items physically shipped to the user in response to one or more electronic transactions of a subscription electronic transactions platform; upon receiving the return notification of the user, determining whether the user is eligible to select one or more wearable items for a replacement physical shipment to the user; as a result of determining that the user is eligible to select one or more wearable items for the replacement physical shipment to the user, obtaining information regarding a plurality of predetermined wearable items from one or more data storages of the subscription electronic transactions platform; displaying the obtained information regarding the plurality of predetermined wearable items; and determining whether the user provides input based on the displayed information regarding the plurality of predetermined wearable items during a predetermined period of time.

In accordance with another embodiment, a non-transitory computer-readable medium containing instructions that, when executed by a processor, causes the processor to perform a method. The method may include: receiving a return notification of a user for one or more wearable items physically shipped to the user in response to one or more electronic transactions of a subscription electronic transactions platform; upon receiving the return notification of the user, determining whether the user is eligible to select one or more wearable items for a replacement physical shipment to the user; as a result of determining that the user is eligible to select one or more wearable items for the replacement physical shipment to the user, obtaining information regarding a plurality of predetermined wearable items from one or more data storages of the subscription electronic transactions platform; displaying the obtained information regarding the plurality of predetermined wearable items; and determining whether the user provides input based on the displayed information regarding the plurality of predetermined wearable items during a predetermined period of time.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment in which methods, systems, and other aspects of the present disclosure may be implemented.

FIGS. 2A-2B depict exemplary embodiments of allocating one or more wearable items to a replacement physical shipment for an electronic clothing subscription transactions platform according to some embodiments.

FIG. 3 depicts an exemplary method for determining one or more wearable items according to some embodiments.

FIG. 4 depicts an exemplary method for assigning one or more wearable items according to some embodiments.

FIGS. 5-6 depict exemplary methods of collision management according to some embodiments.

FIG. 7 depicts an exemplary computer device or system, in which embodiments of the present disclosure, or portions thereof, may be implemented.

### DETAILED DESCRIPTION OF EMBODIMENTS

Reference will now be made in detail to the exemplary embodiments of the disclosure, examples of which are illustrated in the accompanying drawings. Wherever possible, the same reference numbers will be used throughout the drawings to refer to the same or like parts.

The present disclosure relates to an electronic transaction platform for enabling subscribing users with subscribing to, renting, and/or purchasing wearable items (e.g., clothing, apparel, etc.). In some embodiments, a user may select one or more wearable items from a catalog provided by the electronic transaction platform. The catalog may include information relating to several, e.g., hundreds to thousands of, wearable items. In some embodiments, the selected one or more wearable items may be included in a “virtual closet,” as will be described in further detail below. In some embodiments, the user may indicate that the user will be returning one or more wearable items currently in their possession that had been sent to them in a previous shipment. In such embodiments, the electronic transaction platform may then determine whether the user is eligible to select one or more wearable items included in the catalog and/or the virtual closet for a next physical shipment (replacement shipment) of wearable items. If the user is not eligible to select one or more wearable items for the replacement shipment, the electronic transaction platform may automatically determine one or more wearable items for the user and allocate the determined one or more wearable items for the replacement shipment.

If the user is deemed eligible to select one or more wearable items for the replacement shipment, a panel including information relating to one or more wearable items included in the catalog and/or the virtual closet may be displayed to the user. If the user makes a selection of wearable items from the displayed wearable items within a predetermined period of time, the electronic transaction platform may allocate the selected wearable items for the replacement shipment. If the user does not make a selection within the predetermined period of time, the electronic transaction platform may automatically determine one or more wearable items for the user and allocate the determined one or more wearable items for the replacement shipment.

While the exemplary system architecture as described in the present disclosure relates to electronic transaction platform for subscribing to, renting, and/or purchasing wearable items (e.g., clothing-as-a-service (CaaS) or Try-Then-Buy (TTB) service), implementations disclosed herein may effectively serve various other online transaction platforms in the context of any other subscription, purchase, rental, or retail services without departing from the scope of the disclosure. In addition, while some descriptions and examples disclosed in the present disclosure refer to certain exemplary transaction platforms or inventories as transactions or inventories pertaining to “apparel,” “garments,” or “CaaS” (i.e., clothing-as-a-service), all of those transactions and/or inventories may effectively serve any wearable item (e.g., an article of clothing, apparel, jewelry, hat, accessories, or any other product which may be worn), or even hospitality linens, consumer goods, or any other textile fabrics, without departing from the scope of the disclosure.

As used in the present disclosure, the term “CaaS” (i.e., clothing-as-a-service) may collectively refer to computer-implemented services and functions associated with subscription, purchase, and/or rental services for users (e.g., periodic subscription for receiving wearable items, apparel rental or purchase order, distribution, return processing, TTB services, account management, marketing, customer service, warehouse operations, etc.). As used in the present disclosure, the term “wearable item” may refer to any article of clothing, apparel, jewelry, hat, accessories, or other product which may be worn by a person, an animal, or a thing, or be used as an ornament for a person, an animal, or a thing. As used herein, the term “closeting” or “to closet” may refer to a computer-implemented operation of placing one or more garments into a virtual closet (e.g., a cart, a repository, or any type of space which may be virtually associated with a particular set of one or more garments for a future transaction). Additionally, “matching” may refer to a computer-implemented operation of determining a set of one or more garments for allocating to a user and/or determining wearability metrics for given garments, and “allocating” or “allocation” may refer to a computer-implemented operation of determining the garments that should be assigned and shipped to one or more particular users.

In accordance with the present disclosure, user interfaces, periodically executed computer-implemented services, ad hoc services, and automations being integrated together in a connected platform may be achieved by a uniquely configured system architecture, job execution cluster configuring one or more processors to perform both storefront and back office tasks, and various user interfaces providing specialized or customized access to users of different roles. The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

The subject matter of the present description will now be described more fully hereinafter with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

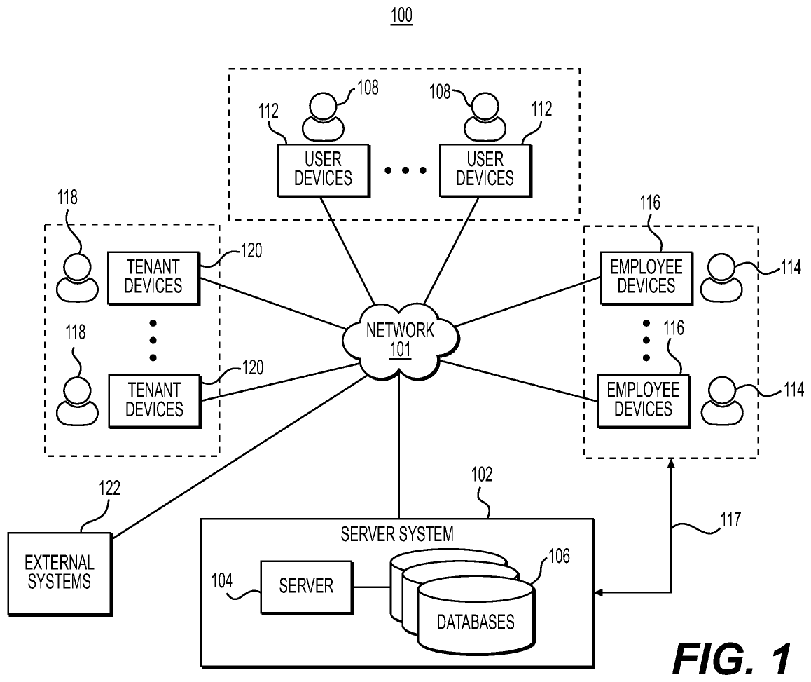

Referring now to the appended drawings, FIG. 1 shows an example environment 100, according to one or more embodiments of the present disclosure. As shown, the example environment 100 may include one or more networks 101 that interconnect a server system 102, user devices 112, employee devices 116, tenant devices 120, and external systems 122. The one or more networks 101 may be, for example, one or more of a cellular network, a public land mobile network, a local area network, a wide area network, a metropolitan area network, a telephone network, a private network, an ad hoc network, an intranet, the Internet, a fiber optic based network, a cloud computing network, etc. User devices 112 may be accessed by users 108, employee devices 116 may be accessed by authorized employees 114, and tenant devices 120 may be accessed by employees of tenant entities 118. In some implementations, employee devices 116 may be used to perform the functions of the tenant devices 120 and/or the user devices 112. Server system 102 may comprise one or more servers 104 and one or more databases 106, which may be configured to store and/or process a plurality of data, microservices, and service components, and/or associated functions thereof.

Users 108 may access the server system 102 through the one or more networks 101 using user devices 112. Each device among the user devices 112 may be any type of computing device (e.g., personal computing device, mobile computing devices, etc.) which allows users 108 to display a web browser or a web-based application for accessing the server system 102 through the network 101. The user devices 112 may, for example, be configured to display a web browser, a web-based application, or any other user interface (e.g., one or more mobile applications) for allowing users 108 to exchange information with other device(s) or system(s) in the environment 100 over the one or more networks 101. For example, a device among the user devices 112 may load an application with a graphical user interface (GUI), and the application may display on the GUI one or more apparel recommendations for closeting by the user. Users 108 accessing user devices 112 may be, for example, users and/or potential users of apparel made available for subscription-based distribution via electronic transactions and physical shipment. Additionally, or alternatively, users 108 may access user devices 112 to, for example, manage one or more user accounts, view catalogs, configure one or more user profiles, engage in customer service communications, make purchase orders, track shipments, generate shipments, monitor order fulfillment processes, initiate or process returns, order apparel for purchase, provide feedback, refer other users, navigate through various features such as size advisor, perform personalized discovery, and/or make recommendations.

Employee devices 116 may be configured to be accessed by one or more employees 114, including, for example, customer service employees, marketer employees, warehouse employees, analytics employees, or any other employees who are authorized and/or authenticated to perform tasks, operations, and/or transactions associated with the server system 102, and/or the external systems 122. In one embodiment, employee devices 116 are owned and operated by the same entity or at least an affiliate of the entity operating the e-commerce (e.g., CaaS) business hosted on server systems 102. Each device among the employee devices 116 may be any type of computing device (e.g., personal computing device, mobile computing devices, etc.). The employee devices 116 may allow employees 114 to display a web browser or an application for accessing the server system 102 and/or the external systems 122, through the one or more networks 101. For example, a device among the one or more of the employee devices 116 may load an application with graphical user interface (GUI), and the application may display on the GUI one or more warehouse operations associated with providing CaaS to users 108. In some implementations, the employee devices 116 may communicate directly with the server system 102 via communications link 117 bypassing public networks 101. Additionally, or alternatively, the employee devices 116 may communicate with the server system 102 via network 101 (e.g., access by web browsers or web-based applications).

Tenant devices 120 may be configured to be accessed by one or more tenants 118. Each device among the tenant devices 120 may be any type of computing device (e.g., personal computing device, mobile computing devices, etc.). As used herein, each tenant, among one or more tenants 118, may refer to an entity that allocates and/or supplies one or more specific collections of apparel for the CaaS inventory. For example, each of the one or more tenants 118 may be a retailer, a designer, a manufacturer, a merchandizer, or a brand owner entity that supplies one or more collections of wearable items to the CaaS inventory managed and/or accessed by the server system 102. Tenants 118 may use one or more electronic tenant interfaces (e.g., a catalog content management system associated with each tenant) to provide the server system 102 with wearable item data that describe apparel or wearable items made available for electronic transactions on server system 102. For example, one or more catalogs for each of the one or more tenants 118 may be generated and/or updated at the server system 102 dynamically and/or periodically. Tenant devices 120 may serve as access terminals for the tenants 118, for communicating with the electronic tenant interfaces and/or other subsystems hosted at the server system 102. The tenant devices 120 may, for example, be configured to display a web browser, an application, or any other user interface for allowing tenants 118 to load the electronic tenant interfaces and/or exchange data with other device(s) or system(s) in the environment 100 over the one or more networks 101.

External systems 122 may be, for example, one or more third party and/or auxiliary systems that integrate and/or communicate with the server system 102 in performing various CaaS tasks. External systems 122 may be in communication with other device(s) or system(s) in the environment 100 over the one or more networks 101. For example, external systems 122 may communicate with the server system 102 via API (application programming interface) access over the one or more networks 101, and also communicate with the employee devices 116 via web browser access over the one or more networks 101.

As indicated above, FIG. 1 is provided merely as an example. Other examples that differ from the example environment 100 of FIG. 1 are contemplated within the scope of the present embodiments. In addition, the number and arrangement of devices and networks shown in environment 100 are provided as an example. In practice, there may be additional devices, fewer devices and/or networks, different devices and/or networks, or differently arranged devices and/or networks than those shown in environment 100. Furthermore, two or more devices shown in FIG. 1 may be implemented within a single device, or a single device shown in FIG. 1 may be implemented as multiple, distributed devices. Additionally, or alternatively, one or more devices may perform one or more functions of other devices in the example environment 100. For example, employee devices 116 may be configured to perform one or more functions of tenant devices 120, in addition to their own functions.

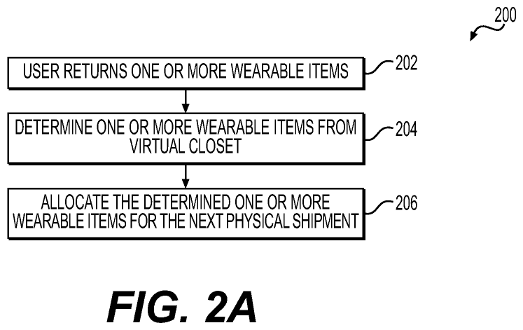

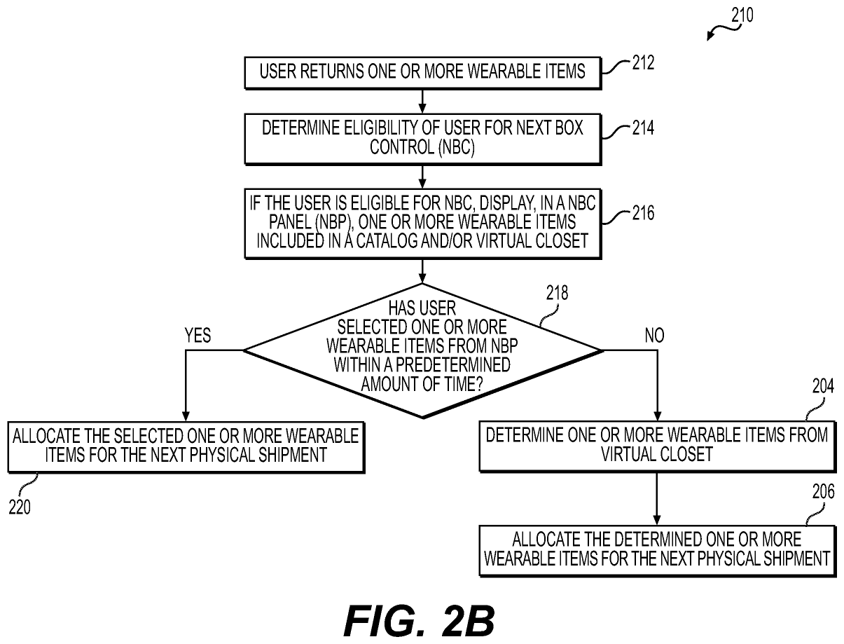

FIG. 2A depicts an exemplary method 200 for allocating one or more wearable items to a next shipment (“next box”) or replacement physical shipment on a subscription electronics transactions platform according to some embodiments. In some embodiments, a user may select one or more items from a catalog including various wearable items. For example, the catalog may include up to several hundred to several thousand wearable items. In such embodiments, the selected one or more items from the catalog may be saved in a queue, also referred to as the “virtual closet.” In some embodiments, the user may select the one or more wearable items for the virtual closet prior to returning one or more wearable items previously sent to the user in an earlier shipment and currently in possession of the user. For example, the user may perform a batch selection of wearable items on a weekly or monthly basis. In some embodiments, the virtual closet for the user may be stored in the one or more databases 106 included in the server system 102.

In step 202, a user may return one or more wearable items previously sent to the user in an earlier shipment, thereby becoming eligible to receive a replacement box with one or more additional wearable items. In some embodiments, the user may transmit a “return notification” indicating that the user will return one or more wearable items previously sent to the user in an earlier shipment. Upon determining that the user has become eligible for the replacement box, a replenishment request may be generated and added to a demand smoothing queue (DSQ). In some embodiments, the DSQ may be a queue maintained on the fulfillment side of the electronic transaction platform (e.g., as opposed to the Virtual Closet which is a customer facing queue provided by the electronic transaction platform) in which replenish requests may be added and maintained in a first-come-first-serve basis. In some embodiments, holding replenishment requests in a DSQ may allow flexibility for the electronic transaction platform for multiple reasons including, but not restricted to, the following: (1) ability to get more liquidity in a matching algorithm by extending the time during which a replenishment request is being matched to available inventory, and (2) ability to control labor costs arising out of warehouse associates needing to pick and pack/handle clothing allocations/shipments by balancing the time for which replenishment requests may be allowed to remain in the queue with the amount of labor and overtime devoted to manage processing time of the replenishment requests. In some embodiments, the replenishment request may be processed within a certain amount of time, e.g., 24, 48, or 72 hours. The amount of time it takes for the replenishment request to be processed may depend on a number of factors including, but not restricted to, the following: how long it typically takes for a user's box to come back to a distribution center from the time the user indicates that return has been initiated (e.g., by transmitting a return notification), a user's feedback on the one or more wearable items being returned, a user's feedback on previously returned wearable items, and an average frequency with which the user requests and receives a box. Once the replenishment request gets processed, the method moves on to step 204.

In step 204, one or more wearable items included in the user's virtual closet may be determined for inclusion in the replacement box. In some embodiments, the server system 102, e.g., CaaS service, may automatically select the one or more wearable items. In some embodiments, the one or more wearable items may be selected based on availability, likelihood of user satisfaction, etc. In some embodiments, the DSQ may work in conjunction with the virtual closet, thereby allowing a higher liquidity in demand and supply, which may result in better chances of matching the user with a wearable item that the user prefers. In step 206, the determined one or more items may be allocated to the next physical shipment.

FIG. 2B depicts an exemplary method 210 for allocating one or more wearable items to a replacement physical shipment on a subscription electronics transactions platform according to some embodiments. In some embodiments, a user may select one or more items from a catalog including various wearable items. For example, the catalog may include up to several hundred to thousand wearable items. In such embodiments, the selected one or more items from the catalog may be saved in a queue, also referred to as the virtual closet. In some embodiments, the user may select the one or more wearable items for the virtual closet prior to returning one or more wearable items previously sent to the user in an earlier shipment and currently in possession of the user. For example, the user may perform a batch selection of wearable items on a weekly or monthly basis. In some embodiments, the virtual closet for the user may be stored in the one or more databases 106 included in the server system 102.

In step 212, a user may return one or more wearable items previously sent to the user in an earlier shipment, thereby becoming eligible to receive a replacement box with one or more wearable items. In some embodiments, the user may transmit a return notification indicating that the user will return one or more wearable items previously sent to the user in an earlier shipment.

In step 214, the eligibility of the user for next box control (NBC) may be determined. More specifically, it may be determined whether the user is eligible to select the one or more wearable items to be allocated to the replacement box. In some embodiments, determination of the user's eligibility in step 214 may be based on, but not restricted to, at least one or more of the following: a number of wearable items in the user's virtual closet, a number of times user has invoked the NBC feature in the recent past, and popularity of the wearable items in the user's virtual closet and likely impact on user satisfaction. If the user is not eligible for NBC, the method 210 may proceed to steps 204 and 206 of method 200 depicted in and described with reference to FIG. 2A.

In step 216, if the user is eligible for NBC, one or more wearable items included in the catalog and/or the Virtual Closet may be displayed in a NBC panel (NBP). In some embodiments, the one or more wearable items included in the catalog and/or the Virtual Closet which are displayed in the NBP may be based on, but not restricted to, at least one or more of the following: popularity of the wearable items in the user's Virtual Closet and likely impact on the user satisfaction, wearable items present and available in the distribution center, wearable items in the catalog that are not in the user's Virtual Closet, but are related to the wearable items in the user's Virtual Closet or have been shown to have a high chance of success for user satisfaction, and wearable Items from the catalog that are displayed in the NBP as part of an explore and exploit algorithm. For example, the exploit algorithm may choose wearable items similar to what a user has liked in the past or predicted wearable items that the user may like, and the explore algorithm may choose wearable items that the user may or may not like, but may learn about user preferences based on feedback from the user regarding the chosen wearable items. In some embodiments, the NBP may be a display panel depicting one or more wearable items included in the GUI associated with user devices 112 as described above. Accordingly, the user may view the displayed wearable items on the NBP via the GUI associated with the user devices 112.

In some embodiments, the NBP may be displayed to the user through multiple triggers including, but not restricted to, one or more of the following: a dedicated navigation menu item configured to lead the user to the NBP when eligible may be displayed to the user at the time the user transmits a return notification via the subscription electronics transactions platform, and a content advertisement or push notification via the GUI associated with user devices 112 that allows the user to access the NBP when eligible at the time the user transmits a return notification via the subscription electronics transactions platform.

In some embodiments, the NBP may further display a service fee that may be required in order to access the NBP. In such embodiments, the price may be dynamically calculated based on a number of features including, but not restricted to, one or more of the following: market willingness to pay, projected impact of allowing the user bypass the system configured to perform method 200 as depicted in and described with reference to FIG. 2A (e.g., the projected impact of allowing the user to utilize the system configured to perform method 210 instead of method 200), and popularity of the wearable items in the NBP.

In step 218, it may be determined whether the user has selected one or more wearable items from the NBP within a predetermined amount of time, e.g., 6 hours, 12 hours, 24 hours etc. In some embodiments, it may be determined whether the user has selected a required number of wearable items from the NBP with the predetermined amount of time. The required number of wearable items may be determined based on a variety of factors including, but not restricted to, the following: a number of items the user is due to receive as part of the upcoming box, policy decisions regarding whether the cost of sending multiple shipments is supported in place of one shipment, whether a new shipment may be sent without incurring additional cost, etc. If the user has not selected one or more wearable items from the NBP or has not selected the required number of wearable items from the NBP within the predetermined amount of time, the method 210 may proceed to step 204 of method 200 depicted in and described with reference to FIG. 2A. If it is determined that the user has selected one or more wearable items from the NBP or selected the required number of wearable items from the NBP within the predetermined amount of time, the method 210 may proceed to step 220. In some embodiments, the method 210 may skip the DSQ and proceed directly to 220 as a result of determining that the user has selected one or more wearable items from the NBP within the predetermined amount of time. In some embodiments, skipping the DSQ may further expedite the delivery of the next physical shipment. In step 220, the selected one or more wearable items from the NBP may be allocated to the next physical shipment.

Significant advantages provided by the current disclosure include, but are not limited to: (1) throttle capability; (2) expedited delivery by reducing processing time before shipping; (3) a time window; and (4) an efficient use of preexisting systems. The advantages are described in further detail below.

With respect to (1) throttle capability, combining two models, e.g., the user picks model and the service picks model, may indicate a significant increase in the costs of operating a service picks model, thereby defeating the purpose (e.g., cost efficient processing) of the service picks model. However, the current disclosure, as explained above with respect to method 210 depicted in FIG. 2B, provides an eligibility check, e.g., the eligibility check in step 214, for the user picks model and explains that the one or more wearable items which may be displayed in the NBP display may be based on certain factors which limits the exposure to cost and risk associated with the user picks model. For example, the one or more wearable items displayed in the NBP display may be based on, but not restricted to, at least one or more of the following: a number of wearable items in the user's virtual closet, a number of times user has invoked the NBC feature in the recent past, and popularity of the wearable items in the user's virtual closet and likely impact on user satisfaction, etc. Such steps, e.g., the eligibility check in step 214 and the selection of one or more wearable items to be displayed in the NBP display based on certain factors, may be referred to as a virtual throttling lever that may increase or decrease exposure to the user picks model to balance the risk and opportunity associated with the user picks model in combination with the service picks model.

With respect to (2) expedited delivery, the ability to expedite the delivery, thereby reducing the net turn-around time of the next shipment to the user, may allow improved flexibility regarding how the expedited delivery feature may be displayed (e.g., marketed and/or advertised) to the user. For example, positioning this feature to choose certain wearable items may be displayed to the user as “Expedited Delivery.” Accordingly, the resultant package of multiple components (e.g. the expedited delivery feature and the ability to select certain wearable items within a service picks model) provided to the user may increase the perceived value of the facility to the user and may increase the electronic transaction platform's ability to meet unmet user needs. In some embodiments, the DSQ may be skipped in some embodiments, as noted above, thereby expediting the delivery of the next physical shipment.

With respect to (3) the time window, the current disclosure describes a predetermined time period (also referred to as a time window) in which the user may select one or more wearable items from NBP, as depicted and described with reference to FIG. 2B. The use of the time window may allow the user to seamlessly switch from a user picks model to a service picks model, and vice versa. The time window allows the decoupling of a time period within which the user eligibility for a next box, e.g., a replacement box, is determined from a time period within which it is determined whether the user has indeed made a selection of one or more wearable items from NBP or the user has made the required number of wearable item selections from the NBP. This decoupling may provide the user with a larger time window to make a selection from the NBP for the next box.

With respect to (4) the efficient use of preexisting systems, the current disclosure describes systems and methods providing a seamless integration of various service models (e.g., user picks model and the service picks model). In some embodiments, the systems and methods disclosed herein may efficiently utilize one or more aspects of existing service picks models to provide seamless transition between the various service models, such as the user picks model. For example, the systems and methods disclosed herein may reuse a desirability signal. Conventional services that provide a user picks model may require a user to make a selection in real-time which means that the user has to effectively start from scratch and process a relatively large number of wearable items from a catalog and make a selection in a relatively short period of time for every shipment/box. For example, conventional services that provide a user picks model may have a high opportunity cost to the user, e.g., a shipment may get delayed to a next day because the user had not selected wearable times in the relatively short period of time, such as, 9 am through noon, during the current day. The current disclosure explains that the utilization of the virtual closet, as described above with reference to FIGS. 2A-2B, such that the user gets a head start in terms of obtaining a shortlist of wearable items from which to select from (also referred to as “repurposing the virtual closet”) instead of having to go through a large portion of the entire catalog which may contain wearable items that may be relevant to any given user at any given time as opposed to wearable items included in a user's virtual closet that contains wearable items highly relevant to a user's preference as the user had previously selected the items in the virtual closet prior to having to make a selection for the next shipment/box.

Additionally, with respect to (4) the efficient use of preexisting systems, the current disclosure describes repurposing an upcoming box through the user picks model, but skipping the DSQ in some embodiments. This may provide an expedited delivery sufficient to match the user's expected urgency some instances. This may also minimize shipping costs and better balance the user's demands regarding urgency with final service costs that the user may have to pay for utilizing the user picks model as disclosed herein.

Some additional advantages provided by the current disclosure include, but are not limited to: (1) an inventory management system that supports both the everyday use case model and the occasion use case model; (2) a scalable multi-agent allocation system configured to provide multiple service models (e.g., the everyday use case model and the occasion use case model), seamless transition between various service models, and targeting of global optimization objectives in shipping from both the multiple service models and further enabling a framework that may introduce additional and different service models; and (3) a service based on a real-time algorithm configured to generate relevant wearable item candidates for users eligible to select one or more wearable items for an initial and/or a replacement shipment and guarantee shipping of the selected one or more wearable items.

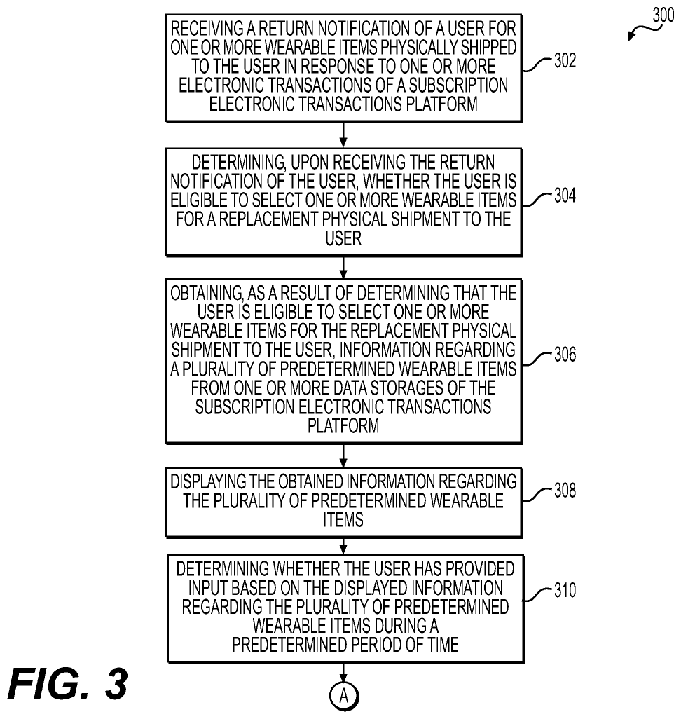

FIG. 3 depicts an exemplary method 300 for determining one or more wearable items. The method 300 includes step 302, a return notification of a user may be received for one or more wearable items physically shipped to the user in response to one or more electronic transactions of a subscription electronic transactions platform. In step 304, it may be determined, upon receiving the return notification of the user, whether the user is eligible to select one or more wearable items for a replacement physical shipment to the user. In step 306, information regarding a plurality of predetermined wearable items may be obtained from one or more data storages of the subscription electronic transactions platform as a result of determining that the user is eligible to select one or more wearable items for the replacement physical shipment to the user. In step 308, the obtained information regarding the plurality of predetermined wearable items may be displayed. In step 310, it may be determined whether the user provides input based on the displayed information regarding the plurality of predetermined wearable items during a predetermined period of time. In some embodiments, the provided input may include a selection of one or more wearable items from the plurality of predetermined wearable items. In some embodiments, the provided input may include a selection of a required number of wearable items from the plurality of predetermined wearable items.

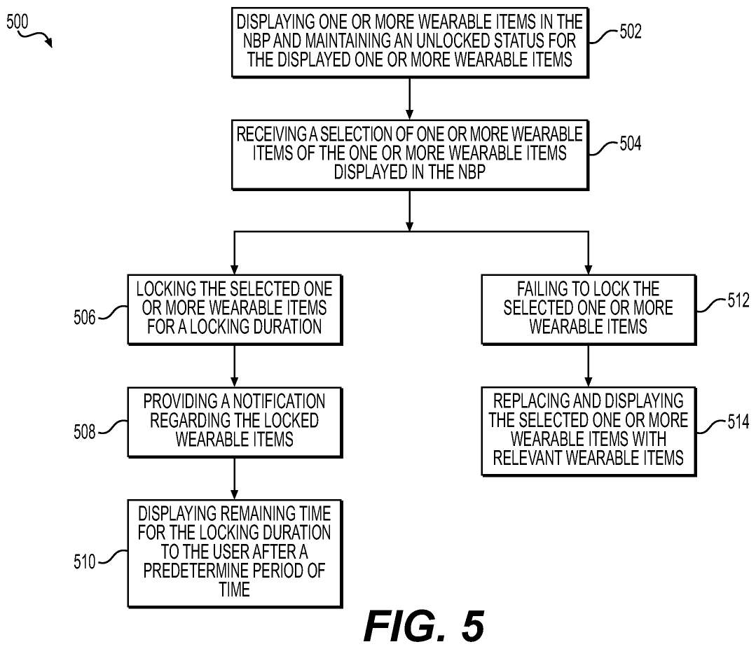

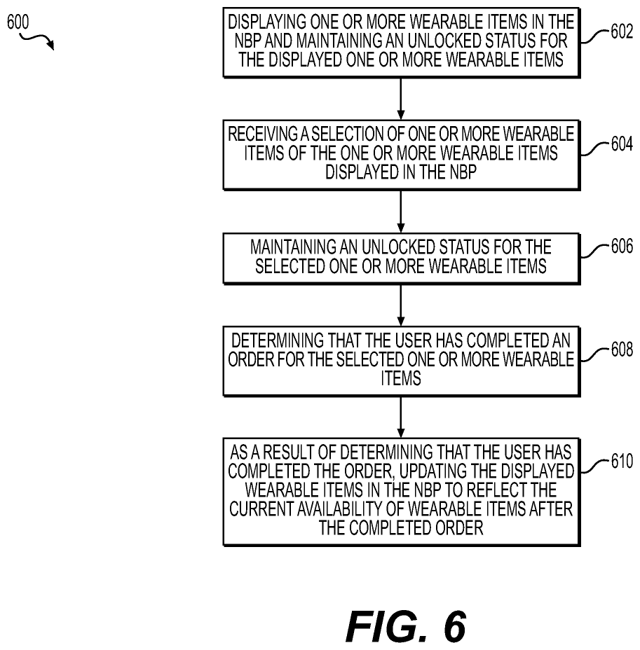

In some embodiments, a different user may submit an input regarding one or more of the displayed plurality of predetermined wearable items prior to the input provided by the user in step 310. For example, the different user may select one or more of the predetermined wearable items displayed to the user and the user may be unaware that the selected one or more wearable items may no longer be available. Accordingly, there may instances where the user selects a displayed wearable item that is no longer available. In the context of the current disclosure, such a situation may be referred to as a “collision.” Exemplary embodiments of managing such situations (hereinafter referred to as “collision management”) are described in further detail below with reference to FIGS. 5-6.

In some embodiments, determining whether the user is eligible to select one or more wearable items for a replacement physical shipment to the user may include determining the eligibility based on, but not restricted to, at least one or more of: a number of wearable items included in the plurality of predetermined wearable items, a popularity associated with each wearable item included in the plurality of predetermined wearable items, and previous determinations regarding whether the user is eligible to select one or more wearable items for the replacement physical shipment to the user.

In some embodiments, the information regarding the plurality of predetermined wearable items is based on, but not restricted to, at least one or more of: one or more wearable items previously selected by the user, currently available wearable items via the subscription electronic transactions platform, and wearable items associated with the one or more wearable items previously selected by the user.

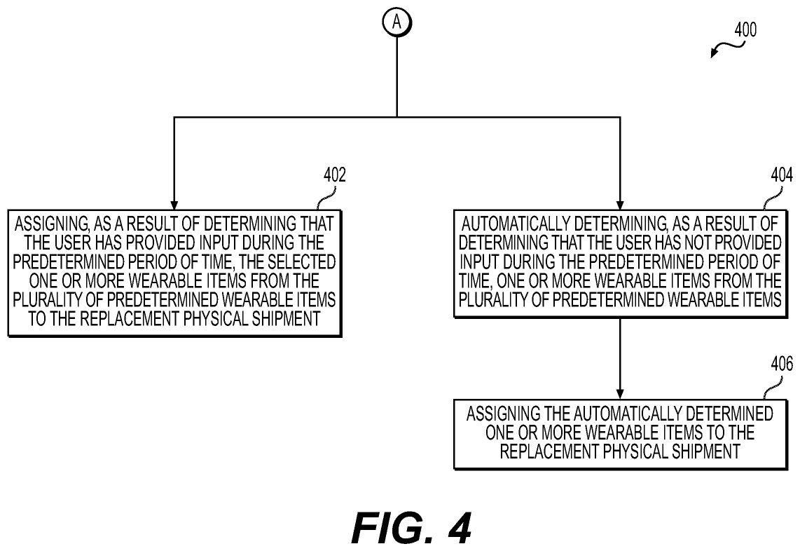

FIG. 4 depicts an exemplary method 400 for assigning one or more wearable items. In some embodiments, method 400 may be an extension of method 300, as indicated by step A in FIGS. 3 and 4.

In step 404, one or more wearable items may be automatically determined from the plurality of predetermined wearable items as a result of determining that the user has not provided input during the predetermined period of time. In step 406, the automatically determined one or more wearable items may be assigned to the replacement physical shipment. As disclosed herein, steps 404 and 406 may be referred to as the service picks model (the everyday model). The service picks model, e.g., steps 404 and 406, may be the default steps for methods 300 and 400 unless a user input is detected in step 310, as described above, in which case the methods 300 and 400 may proceed to step 402.

In step 402, the one or more wearable items selected from the plurality of predetermined wearable items may be assigned to the replacement physical shipment as a result of determining that the user has provided input during the predetermined period of time. As disclosed herein, step 402 may be referred to as the user picks model (the occasion model). As described above, the provided input may include the provided input may include the selection of one or more wearable items from the plurality of predetermined wearable items. In some embodiments, the provided input may include a selection of a required number of wearable items from the plurality of predetermined wearable items.

FIGS. 5-6 depict exemplary methods 500, 600 for collision management according to some embodiments. The embodiments for collision management disclosed herein may provide a sufficient balance between the following objectives: (1) ensuring more wearable items are shown in the NBP in aggregate; (2) minimizing the feeling of disappointment that a user may have when the user selects an item and it turns out the item is no longer available when the user attempts to confirm the order; and (3) minimizing the amount of a cognitive load a user may experience when the user is shown a time window or an expiry window to make a decision, e.g., a decision to complete an order for a selected wearable item.

While two methods 500, 600 are depicted in and described below with reference to FIGS. 5-6, it is understood that other methods may be utilized in alternative embodiments to optimize collision management and maximize aggregate utility of the electronic transaction platform.

As shown in FIG. 5, method 500 may begin with step 502 in which the one or more wearable items displayed in the NBP (e.g., the plurality of predetermined wearable items displayed to a user in step 308 of FIG. 3) are not locked for selection and/or display to other users. In step 504, a user may provide input for one or more wearable items, e.g., the user may select the one or more wearable items, based on the wearable items displayed in the NBP. In step 506, the selected wearable items may be locked, i.e., become no longer available to the other users on the electronic transaction platform, once the user selects the wearable items. In some embodiments, a timer (e.g., a timer for five minutes) (hereinafter referred to as the “lock duration”) for the locked item may be triggered as soon as the wearable item is selected by the user, i.e., becomes locked. In step 508, once the selected items are locked, a lock notification, e.g., visual and/or audible notification, may be displayed to the user indicating that the selected items have been locked. Throughout the lock duration, the locked wearable items may not be displayed and/or otherwise accessible to other users of the electronic transaction platform. In some embodiments, the timer may not be displayed to the user in the lock notification. In some embodiments, method 500 may include additional step 510 in which the timer may be displayed to the user after a predetermined period of time or when a predetermined period of time is left for the lock duration. For example, the timer may be displayed to the user when there is minute left on the timer and the user has not completed an order for the selected wearable items. In the context of the current disclosure, the period during which the timer is displayed to the user may be referred to as the “visible duration.” It is understood that any duration of time may be utilized for the lock duration and the visible duration in alternative embodiments.

In some embodiments, method 500 may include additional step 512 in which the wearable items selected by the user may not be locked. For example, the selected wearable items may have been selected by the other users before the user was able to select the wearable items. In such embodiments, method 500 may include additional step 514 in which the selected wearable items may be replaced with other relevant wearable items that may be currently available, i.e., not currently locked. In some embodiments, the replaced wearable items may be displayed along with the previously displayed wearable items in the NBP.

FIG. 6 depicts a method 600 of collision management according to some embodiments. Method 600 may begin with step 602 in which the one or more wearable items displayed in the NBP (e.g., the plurality of predetermined wearable items displayed to a user in step 308 of FIG. 3) are not locked for selection and/or display to other users. In step 604, a user may provide input based for one or more wearable items, e.g., the user may select the one or more wearable items, based on the wearable items displayed in the NBP. In step 606, the selected one or more wearable items remain unlocked, i.e., the selected items are not locked. In step 608, the system may determine that the user has completed an order for the selected one or more wearable items. In step 610, as a result of determining that the user has completed the order for the selected one or more wearable items, the displayed wearable items in the NBP may be updated to reflect the current availability of the wearable items after the completed order.

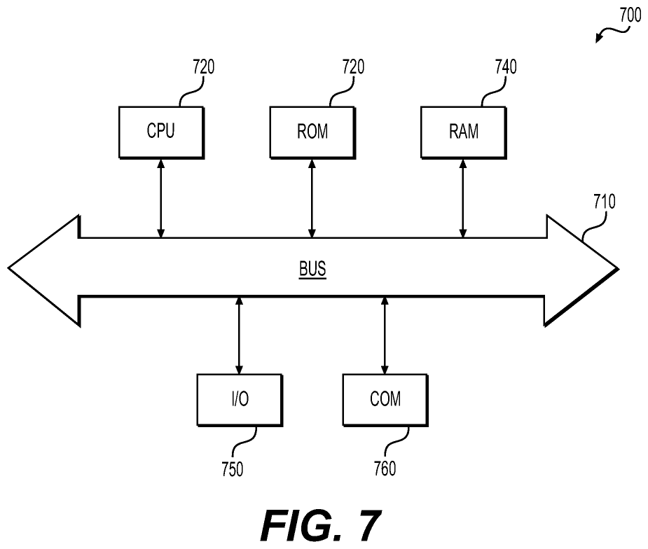

As shown in FIG. 7, a device 700 used for performing the various embodiments of the present disclosure (e.g., the server system 102, the user devices 112, the employee devices 116, the tenant devices 120, and/or any other computer system or user terminal for performing the various embodiments of the present disclosure) may include a central processing unit (CPU) 720. CPU 720 may be any type of processor device including, for example, any type of special purpose or a general-purpose microprocessor device. As will be appreciated by persons skilled in the relevant art, CPU 720 also may be a single processor in a multi-core/multiprocessor system, such system operating alone, or in a cluster of computing devices operating in a cluster or server farm. CPU 720 may be connected to a data communication infrastructure 710, for example, a bus, message queue, network, or multi-core message-passing scheme.

A device 700 (e.g., the server system 102, the user devices 112, the employee devices 116, the tenant devices 120, and/or any other computer system or user terminal for performing the various embodiments of the present disclosure) may also include a main memory 740, for example, random access memory (RAM), and may also include a secondary memory 730. Secondary memory, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 730 may include other similar means for allowing computer programs or other instructions to be loaded into device 700. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 700.

A device 700 may also include a communications interface (“COM”) 760. Communications interface 760 allows software and data to be transferred between device 700 and external devices. Communications interface 760 may include a modem, a network interface (such as an Ethernet card), a communications port, a PCMCIA slot and card, or the like. Software and data transferred via communications interface may be in the form of signals, which may be electronic, electromagnetic, optical, or other signals capable of being received by communications interface 760. These signals may be provided to communications interface 760 via a communications path of device 700, which may be implemented using, for example, wire or cable, fiber optics, a phone line, a cellular phone link, an RF link or other communications channels.

The hardware elements, operating systems, and programming languages of such equipment are conventional in nature, and it is presumed that those skilled in the art are adequately familiar therewith. A device 700 also may include input and output ports 750 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It is intended that the specification and examples be considered as exemplary only, with a true scope and spirit of the disclosure being indicated by the following claims.

1. A computer-implemented method comprising:
receiving, by one or more processors, a return notification message from a user indicating that the user intends to return one or more wearable items physically shipped to the user in response to one or more electronic transactions of a subscription electronic transactions platform;
upon receiving the return notification message from the user, determining, by the one or more processors, whether the user is eligible to select one or more wearable items for a replacement physical shipment to the user;
as a result of determining that the user is eligible to select one or more wearable items for the replacement physical shipment to the user, obtaining, by the one or more processors, information regarding a plurality of predetermined wearable items stored in relation to the user in a first queue of one or more data storage devices of the subscription electronic transactions platform and adding a request for the replacement physical shipment to a second queue of the one or more data storage devices of the subscription electronic transactions platform, the second queue configured to receive and maintain a plurality of requests for replacement physical shipments associated with a plurality users;
displaying, by the one or more processors, the obtained information regarding the plurality of predetermined wearable items;
determining, by the one or more processors, that the user has selected one or more wearable items from the first queue based on the displayed information regarding the plurality of predetermined wearable items during a predetermined period of time;
determining, by the one or more processors, whether the number of selected one or more wearable items equals or exceeds a predetermined threshold; and
as a result of determining that the number of selected one or more wearable items equals or exceeds the predetermined threshold, assigning, by the one or more processors, the selected one or more wearable items to the replacement physical shipment and expediting delivery of the replacement physical shipment by skipping the second queue for the request for the replacement physical shipment.

2-3. (canceled)

4. The computer-implemented method of claim 1, further comprising:
as a result of determining that the user has not selected one or more wearable items during the predetermined period of time, automatically determining, by the one or more processors, one or more wearable items from the plurality of predetermined wearable items.

5. The computer-implemented method of claim 4, further comprising:
assigning, by the one or more processors, the automatically determined one or more wearable items to the replacement physical shipment.

6. The computer-implemented method of claim 1, wherein determining whether the user is eligible to select one or more wearable items for a replacement physical shipment to the user comprises:
determining the eligibility based on at least one or more of: a number of wearable items included in the plurality of predetermined wearable items, a popularity associated with each wearable item included in the plurality of predetermined wearable items, and previous determinations regarding whether the user is eligible to select one or more wearable items for the replacement physical shipment to the user.

7. The computer-implemented method of claim 1, further comprising:
as a result of determining that the number of selected one or more wearable items is less than the predetermined threshold, automatically determining, by the one or more processors, one or more wearable items from the plurality of predetermined wearable items; and
assigning, by the one or more processors, the automatically determined one or more wearable items to the replacement physical shipment.

8. A computer system comprising:
a data storage device storing processor-readable instructions; and
a processor configured to execute the instructions to perform a method including:
receiving a return notification message from a user indicating that the user intends to return one or more wearable items physically shipped to the user in response to one or more electronic transactions of a subscription electronic transactions platform;
upon receiving the return notification message from the user, determining whether the user is eligible to select one or more wearable items for a replacement physical shipment to the user;
as a result of determining that the user is eligible to select one or more wearable items for the replacement physical shipment to the user, obtaining information regarding a plurality of predetermined wearable items stored in relation to the user in a first queue of one or more data storage devices of the subscription electronic transactions platform and adding a request for the replacement physical shipment to a second queue of the one or more data storage devices of the subscription electronic transactions platform, the second queue configured to receive and maintain a plurality of requests for replacement physical shipments associated with a plurality users;
displaying the obtained information regarding the plurality of predetermined wearable items;
determining that the user has selected one or more wearable items from the first queue based on the displayed information regarding the plurality of predetermined wearable items during a predetermined period of time;
determining whether the number of selected one or more wearable items equals or exceeds a predetermined threshold; and
as a result of determining that the number of selected one or more wearable items equals or exceeds the predetermined threshold, assigning the selected one or more wearable items to the replacement physical shipment and expediting delivery of the replacement physical shipment by skipping the second queue for the request for the replacement physical shipment.

9-10. (canceled)

11. The computer system of claim 8, wherein the processor is further configured for:
as a result of determining that the user has not selected one or more wearable items during the predetermined period of time, automatically determining one or more wearable items from the plurality of predetermined wearable items.

12. The computer system of claim 11, wherein the processor is further configured for:
assigning the automatically determined one or more wearable items to the replacement physical shipment.

13. The computer system of claim 8, wherein determining whether the user is eligible to select one or more wearable items for a replacement physical shipment to the user comprises:
determining the eligibility based on at least one or more of: a number of wearable items included in the plurality of predetermined wearable items, a popularity associated with each wearable item included in the plurality of predetermined wearable items, and previous determinations regarding whether the user is eligible to select one or more wearable items for the replacement physical shipment to the user.

14. The computer system of claim 8, wherein the processor is further configured for:
as a result of determining that the number of selected one or more wearable items is less than the predetermined threshold, automatically determining one or more wearable items from the plurality of predetermined wearable items; and
assigning the automatically determined one or more wearable items to the replacement physical shipment.

15. A non-transitory computer-readable medium containing instructions that, when executed by a processor, cause the processor to perform a method comprising:
receiving a return notification message from a user indicating that the user intends to return one or more wearable items physically shipped to the user in response to one or more electronic transactions of a subscription electronic transactions platform;
upon receiving the return notification message from the user, determining whether the user is eligible to select one or more wearable items for a replacement physical shipment to the user;
as a result of determining that the user is eligible to select one or more wearable items for the replacement physical shipment to the user, obtaining information regarding a plurality of predetermined wearable items stored in relation to the user in a first queue of one or more data storage devices of the subscription electronic transactions platform and adding a request for the replacement physical shipment to a second queue of the one or more data storage devices of the subscription electronic transactions platform, the second queue configured to receive and maintain a plurality of requests for replacement physical shipments associated with a plurality users;
displaying the obtained information regarding the plurality of predetermined wearable items;
determining that the user has selected one or more wearable items from the first queue based on the displayed information regarding the plurality of predetermined wearable items during a predetermined period of time;
determining whether the number of selected one or more wearable items equals or exceeds a predetermined threshold; and
as a result of determining that the number of selected one or more wearable items equals or exceeds the predetermined threshold, assigning the selected one or more wearable items to the replacement physical shipment and expediting delivery of the replacement physical shipment by skipping the second queue for the request for the replacement physical shipment.

16-17. (canceled)

18. The non-transitory computer-readable medium of claim 15, the method further comprising:
as a result of determining that the user has not provided input during the predetermined period of time, automatically determining one or more wearable items from the plurality of predetermined wearable items; and
assigning the automatically determined one or more wearable items to the replacement physical shipment.

19. The non-transitory computer-readable medium of claim 15, wherein determining whether the user is eligible to select one or more wearable items for a replacement physical shipment to the user comprises:
determining the eligibility based on at least one or more of: a number of wearable items included in the plurality of predetermined wearable items, a popularity associated with each wearable item included in the plurality of predetermined wearable items, and previous determinations regarding whether the user is eligible to select one or more wearable items for the replacement physical shipment to the user.

20. The non-transitory computer-readable medium of claim 15, the method further comprising:
as a result of determining that the number of selected one or more wearable items is less than the predetermined threshold, automatically determining one or more wearable items from the plurality of predetermined wearable items; and
assigning the automatically determined one or more wearable items to the replacement physical shipment.

21. The computer-implemented method of claim 1, wherein the first queue comprises a virtual closet.

22. The computer-implemented method of claim 1, wherein the second queue comprises a demand smoothing queue.

23. The computer-implemented method of claim 1, wherein displaying the obtained information regarding the plurality of predetermined wearable items comprises:
displaying any combination of the plurality of predetermined wearable items on a user interface.

24. The computer-implemented method of claim 23, wherein displaying the obtained information regarding the plurality of predetermined wearable items further comprises:
displaying any combination of the plurality of predetermined wearable items on a display panel via the user interface.
